(19) United States
(12) Patent Application Publication
(10) Pub. No.: US 2005/0129839 A1
(43) Pub. Date: Jun. 16, 2005

(54) Substrate processing apparatus and substrate processing method

(75) Inventor: Masahiro Numakura, Miyagi-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Tokyo Electron Limited, Minato-ku (JP)

(21) Appl. No.: 10/987,035

(22) Filed: Nov. 15, 2004

Related U.S. Application Data
(63) Continuation of application No. PCT/JP03/05597, filed on May 2, 2003.

(30) Foreign Application Priority Data
May 15, 2002 (JP) 2002-139775

(51) Int. Cl. B05D 5/12

(52) U.S. Cl. 427/58; 118/696

(57) ABSTRACT

In a controller MC, information on a process room (PM) (last process PM) which carried out a process last for the previous lot is stored. When starting processing for the current lot, the semiconductor wafers Ware loaded in process rooms, beginning with the process room next to the last process PM (for example, a process room (PM2) when the last process PM is a process room (PM1)). This allows the processing sections to be used evenly and minimizes variations in maintenance cycles and in the wearing of parts in the processing sections.

### CROSS REFERENCE TO RELATED APPLICATION

This is a Continuation Application of PCT Application No. PCT/JP03/05597, filed on May 2, 2003, which was not published under PCT Article 21(2) in English. This application is based upon and claims the benefit of priority from the prior Japanese Patent Application No. 2002-139775, filed May 15, 2002, the entire contents of which are incorporated herein by reference.

### TECHNICAL FIELD

The present invention relates to a substrate processing apparatus and a substrate processing method for applying a coating film, etching or the like to a substrate to be processed such as a semiconductor wafer or a glass substrate for a liquid crystal display.

### BACKGROUND ART

A conventional substrate processing apparatus for applying a coating film, etching or the like to a substrate to be processed such as a semiconductor wafer or a glass substrate for a liquid crystal display is known that it is provided with plural processing sections and a transport mechanism which is connected to these processing sections and configured to transport sequentially the substrates to be processed to the plural processing sections by the transport mechanism and to perform the same processing or a different processing by the individual processing sections, thereby effectively using resources, a space and the like and efficiently processing the substrates to be processed.

Such a conventional substrate processing device, e.g., a substrate processing apparatus provided with two processing sections of a first processing section and a second processing section, carries out, for example, the same processing by the first and second processing sections. And, when 25 semiconductor wafers housed in a single cassette are sequentially processed, first, a first semiconductor wafer is loaded into the first processing section, a second semiconductor wafer is loaded into the second processing section while the first semiconductor wafer is being processed by the first processing section, and the first semiconductor wafer is unloaded from the first processing section and a third semiconductor wafer is loaded into the first processing section while the second semiconductor wafer is being processed by the second processing section, thereby performing a series of processing of the 25 semiconductor wafers efficiently in a short period.

But, the conventional substrate processing apparatus configured as described above starts transporting a semiconductor wafer from the first processing section when a single lot is completely processed and the processing is interrupted, and then the cassette housing semiconductor wafers of a next lot to be processed is loaded to start the processing of the semiconductor wafers in the cassette. Therefore, for example, when the 25 semiconductor wafers in the cassette are processed, thirteen semiconductor wafers are processed by the first processing section and twelve semiconductor wafers are processed by the second processing section. Therefore, the first processing section and the second processing section are not used evenly, resulting in a possibility of variations in maintenance cycles and in the wearing of parts in the processing sections.

### SUMMARY OF THE INVENTION

According to an aspect of the present invention, there is provided a substrate processing apparatus and a substrate processing method, allowing individual processing sections to be used evenly and suppressing occurrence of variations in maintenance cycles and in the wearing of parts in the processing sections.

The substrate processing apparatus of the present invention is a substrate processing apparatus, comprising plural processing sections for carrying out a prescribed processing on a substrate to be processed; a transport mechanism for transporting the substrate to be processed to the plural processing sections in prescribed sequence; and a control unit for storing information on the processing section having processed the substrate to be processed last among the plural processing sections and controlling the transport mechanism to start transporting the substrate to be processed to the processing section which is next in sequence to the stored processing section when a next processing is started.

The substrate processing apparatus according to the present invention also comprises plural processing sections for carrying out a prescribed processing on a substrate to be processed; a transport mechanism for transporting the substrate to be processed to the plural processing sections; and a control unit for storing each integration processing time of the plural processing sections and controlling the transport mechanism to start transporting the substrate to be processed to the processing section having the stored least integration processing time when a next processing is started.

The substrate processing apparatus of the present invention is the above-described substrate processing apparatus, wherein the control unit controls the transport mechanism to transport the substrate to be processed to the processing sections in increasing order of their stored integration processing time. The substrate processing apparatus of the present invention comprises plural processing sections for carrying out a prescribed processing on a substrate to be processed; a transport mechanism for transporting the substrate to be processed to the plural processing sections; and a control unit for storing each integrated processed number of the plural processing sections and controlling the transport mechanism to start transporting the substrate to be processed to the processing section having the stored least integrated processed number when a next processing is started.

The substrate processing apparatus of the present invention is the above-described substrate processing apparatus, wherein the control unit controls the transport mechanism to transport the substrate to be processed to the processing sections in increasing order of their stored integrated processed number. The substrate processing apparatus of the present invention is the above-described substrate processing apparatus, wherein the control unit controls to transport the substrate to be processed to the processing section having the highest priority among those capable of accepting the substrate to be processed when the processing section, to which the substrate to be processed is transported, does not become ready to accept the substrate to be processed even after the expiration of a prescribed time interval.

The substrate processing apparatus of the present invention is the above-described substrate processing apparatus, wherein the processing sections each have a load lock room, and the transport mechanism is configured to transport the substrate to be processed to the load lock room. And, the substrate processing apparatus of the present invention is the above-described substrate processing apparatus, wherein the plural processing sections carry out the same processing.

The substrate processing method of the present invention is a substrate processing method using a substrate processing apparatus which is provided with plural processing sections for carrying out a prescribed processing on a substrate to be processed and a transport mechanism for transporting the substrate to be processed to the plural processing sections in prescribed sequence, wherein information on the processing section having processed the substrate to be processed last among the plural processing sections is stored and the substrate to be processed is started to be transported to the processing section which is next in sequence to the stored processing section when a next processing is started.

The substrate processing method of the present invention is a substrate processing method using a substrate processing apparatus which is provided with plural processing sections for carrying out a prescribed processing on a substrate to be processed and a transport mechanism for transporting the substrate to be processed to the plural processing sections in prescribed sequence, wherein each integration processing time of the plural processing sections is stored, and transporting of the substrate to be processed to the processing section having the stored least integration processing time is started when a next processing is started. The substrate processing method of the present invention is the above-described substrate processing method, wherein the substrate to be processed is transported to the processing sections in increasing order of their stored integration processing time.

The substrate processing method of the present invention is a substrate processing method using a substrate processing apparatus which is provided with plural processing sections for carrying out a prescribed processing on a substrate to be processed and a transport mechanism for transporting the substrate to be processed to the plural processing sections in prescribed sequence, wherein each integrated processed number by the plural processing sections is stored, and transporting of the substrate to be processed to the processing section having the stored least integrated processed number is started when a next processing is started. The substrate processing method of the present invention is the above-described substrate processing method, wherein the substrate to be processed is transported to the processing sections in increasing order of their stored integrated processed number.

The substrate processing method of the present invention is the above-described substrate processing method, wherein the substrate to be processed is transported to the processing section having the highest priority among those capable of accepting the substrate to be processed when the processing section, to which the substrate to be processed is transported, does not become ready to accept the substrate to be processed even after the expiration of a prescribed time interval.

The substrate processing method of the present invention is the above-described substrate processing method, wherein the processing sections each have a load lock room, and the transport mechanism transports the substrate to be processed to the load lock room.

The substrate processing method of the present invention is the above-described substrate processing method, wherein the plural processing sections carry out the same processing.

### BRIEF DESCRIPTION OF THE DRAWINGS

FIG. 1 is a diagram schematically showing an outline configuration of a substrate processing apparatus according to one embodiment of the present invention.

FIG. 2 is a flowchart showing the operation of one embodiment of the present invention.

FIG. 3 is a diagram schematically showing an outline structure of a substrate processing apparatus according to another embodiment of the present invention.

FIG. 4 is a flowchart showing the operation of another embodiment of the present invention.

FIG. 5 is a flowchart showing the operation of another embodiment of the present invention.

### BEST MODE FOR CARRYING OUT THE INVENTION

Embodiments of the substrate processing apparatus according to the present invention will be described in detail with reference to the drawings.

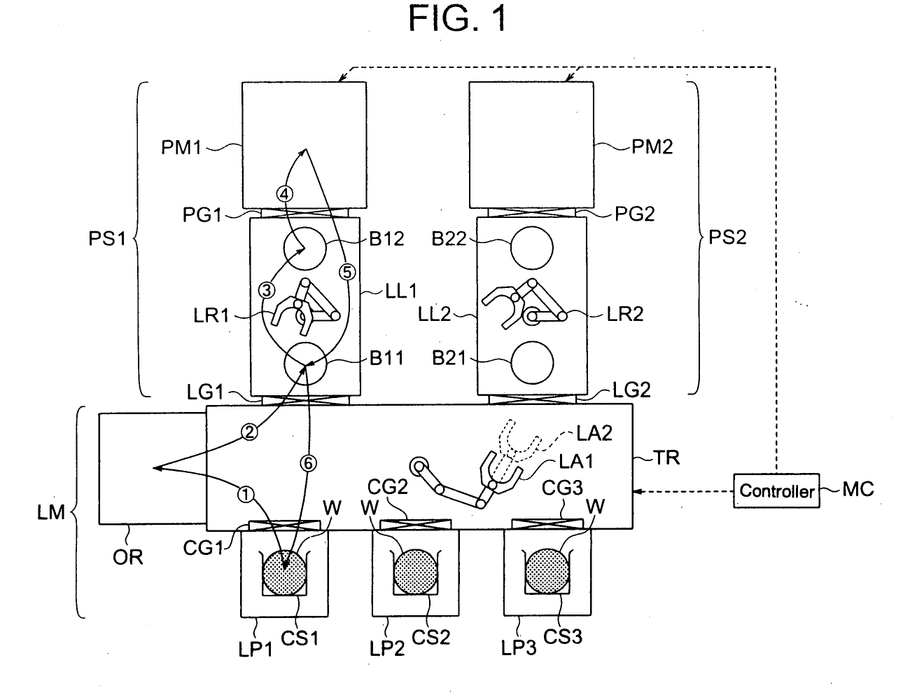

FIG. 1 schematically shows an outline structure of the substrate processing apparatus according to one embodiment of the present invention.

As shown in FIG. 1, the substrate processing apparatus is comprised of a combination of plural (two in the apparatus of FIG. 1) process ships PS1, PS2 each configuring a processing section which performs a prescribed processing on semiconductor wafers W and a loader module LM configuring a transport mechanism for transporting the semiconductor wafers W.

The loader module LM is comprised of plural (three in the apparatus of FIG. 1) load ports LP1 to LP3 for housing the semiconductor wafers W, a transfer room TR for transferring the semiconductor wafers W, and an orienter OR for positioning the semiconductor wafers W.

The transfer room TR is connected to the orienter OR, to the process ships PS1, PS2 via load lock doors LG1, LG2, and to the load ports LP1 to LP3 via load port doors CG1 to CG3. In the load ports LP1 to LP3, cassettes or FOUPs CS1 to CS3 (the cassettes will be described later) for housing the semiconductor wafers W before processing and those after processing are disposed.

The transfer room TR is provided with two-stage structure loader arms LA1, LA2. The loader arms LA1, LA2 transport the semiconductor wafers W between the load ports LP1 to LP3 and the process ships PS1, PS2 (load lock rooms LL1, LL2) and the orienter OR (transport along (1), (2) and (6) in FIG. 1). Here, the loader arms LA1, LA2 have a two-stage structure, so that the semiconductor wafer W is loaded by the loader arms LA1, LA2, and the semiconductor wafer W can also be unloaded by the other loader arms LA2, LA1. Thus, the semiconductor wafers W can be exchanged efficiently.

The process ships PS1, PS2 are provided with load lock rooms LL1, LL2 and process rooms PM1, PM2. The load lock rooms LL1, LL2 and the process rooms PM1, PM2 are mutually connected via process gates PG1, PG2.

The load lock rooms LL1, LL2 are provided with wafer mounting tables B11, B12, B21, B22 and load lock arms LR1, LR2 respectively. On the wafer mounting tables B11, B21, the semiconductor wafers W loaded from the loader module LM are mounted, and the semiconductor wafers W unloaded from the load lock rooms LL1, LL2 are mounted.

The semiconductor wafers W to be loaded into the process rooms PM1, PM2 are mounted on the wafer mounting tables B12, B22. The load lock arms LR1, LR2 transport the semiconductor wafer W between the load lock rooms LL1, LL2 and the process rooms PM1, PM2 (transport along (3), (4), (5) in FIG. 1). Here, to enhance the efficiency of transportation, the transfer room TR is opened to the atmosphere, and the load port doors CG1 to CG3 are kept in an open state. And, the process rooms PM1, PM2 are kept at a prescribed degree of vacuum in order to prevent contamination. Therefore, the load lock rooms LL1, LL2 perform air intake and discharge to comply with the degree of vacuum in the transfer room TR and the process rooms PM1, PM2 depending on the transportation with the transfer room TR or the process rooms PM1, PM2.

A transfer sequence will be described below referring to the transportation between the load port LP1 and the process ship PS1. The substrate processing apparatus as a whole is integrally controlled by the controller MC, and the transfer sequence is also controlled by the controller MC.

First, the loader arms LA1, LA2 take the semiconductor wafers W from the cassette CS1 placed on the load port LP1 to load into the orienter OR ((1)).

When the semiconductor wafer W is loaded, the orienter OR positions the semiconductor wafer W. When the semiconductor wafer W is positioned, the loader arms LA1, LA2 take the semiconductor wafer W from the orienter OR. After the load lock room LL1 is opened to the atmosphere, the load lock door LG1 of the load lock room LL1 is opened. When the load lock door LG1 is opened, the loader arms LA1, LA2 load the semiconductor wafer W into the load lock room LL1 and place it on the wafer mounting table B11 ((2)).

When the semiconductor wafer W is placed on the wafer mounting table B11, the load lock door LG1 is closed. Then, the load lock room LL1 is exhausted, and the load lock arm LR1 transports the semiconductor wafer W from the wafer mounting table B11 onto the wafer mounting table B12 ((3)).

When the semiconductor wafer W is transported onto the wafer mounting table B12 so to be ready to be loaded into the process room PM1, the process gate PG1 of the process room PM1 is opened, the load lock arm LR1 loads the semiconductor wafer W from the wafer mounting table B12 into the process room PM1 ((4)). After the semiconductor wafer W is loaded into the process room PM1, the process gate PG1 is closed, and the semiconductor wafer W is processed in the process room PM1.

After the process room PM1 completes processing the semiconductor wafer W and becomes ready to load it into the load lock room LL1, the process gate PG1 is opened, and the load lock arm LR1 transports the semiconductor wafer W from the process room PM1 onto the wafer mounting table B11 ((5)).

And, the process gate PG1 is closed, and the load lock room LL1 is opened to the atmosphere. After the load lock room LL1 is opened to the atmosphere, the load lock door LG1 is opened depending on the timing of loading a next semiconductor wafer W, the loader arms LA1, LA2 unload the semiconductor wafer W from the wafer mounting table B11 to the load port LP1 ((6)), and the other loader arms LA1, LA2 load the next semiconductor wafer W positioned by the orienter OR into the load lock room LL1 ((2)).

A recipe (execution recipe) to be executed in the process rooms PM1, PM2 is read not in a timing that the semiconductor wafer W is loaded from the load lock rooms LL1, LL2 into the process rooms PM1, PM2 but in a timing that it is loaded from the loader module LM into the load lock rooms LL1, LL2. As a result, by the time that elapses before the semiconductor wafer W enters the process rooms PM1, PM2, a preprocessing (e.g., processing such as temperature setting, self-diagnosis of a flow rate of FCS (Flow Control System) and the like not involving any problem even if the process gates PG1, PG2 between the process rooms PM1, PM2 and the load lock rooms LL1, LL2 are opened) for the next semiconductor wafer W can be performed, and throughput can be improved.

In the substrate processing apparatus configured as described above, when a new lot (single or plural cassettes in which the semiconductor wafers W to be processed next are accommodated) is transported to the load ports LP1 to LP3, a mode can be selected, so that either process rooms PM1, PM2 (the process ships PS1, PS2) are designated and the semiconductor wafer W is transported from the cassette to, for example, the designated process room PM1 (the process ship PS1) only and processed. And, a mode (OR transport mode) can also be selected, so that the semiconductor wafers W are sequentially transported to the two process rooms PM1, PM2 (the process ships PS1, PS2) and can be processed in a short time by the two process rooms PM1, PM2 (the process ships PS1, PS2).

Specifically, 25 semiconductor wafers W are generally housed in a single cassette, and in the OR transport mode, these semiconductor wafers W can be processed in a short time by using sequentially the two process rooms PM1, PM2 (they are set to perform the same processing). A procedure by which the substrate processing apparatus once falling in an idle state starts processing will be described.

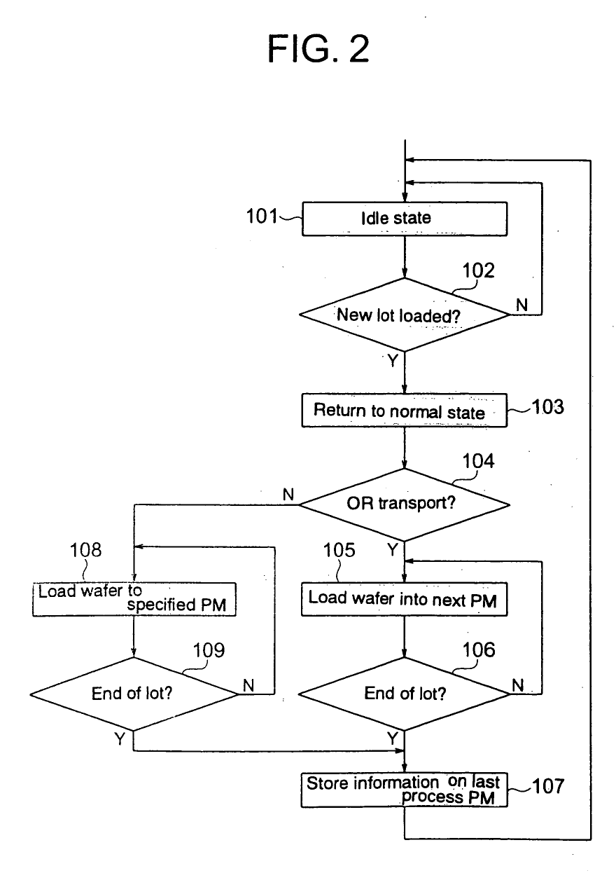

When the processing of one lot of semiconductor wafers W is completed and there is a spare time until the next lot is transported from the previous step, namely when the processing of the semiconductor wafers W by the substrate processing apparatus is interrupted, the substrate processing apparatus falls in an idle mode (101) as shown in FIG. 2 to stand ready.

In the standby state, when the controller MC recognizes that the next and new lot (cassette) is loaded into the load ports LP1 to LP3 (102), a sequence is activated to return the apparatus as a whole from the idle state to the normal state (103).

Then, the controller MC judges whether the next lot is in the OR transport mode (104), and when it is in the OR transport mode, the semiconductor wafer W is started to be loaded into the next process room PM (the process ship PS) (105).

Specifically, information on the process room PM (last process PM) which has processed the last of the previous lot is stored in the controller MC (107), and to start processing the current lot, loading of the semiconductor wafer W to the next process room (e.g., the process room PM2 when the last process PM is the process room PM1) of the last process PM is started.

Then, the semiconductor wafers are sequentially loaded (unloaded) into the two process rooms PM1, PM2 (the process ships PS1, PS2) and processed, and when all the semiconductor wafers W in the one loaded lot are processed (106), information on the process room PM (the last process PM) having performed the last processing is stored (107), and the current processing is terminated.

If the OR transport mode has not been selected (104), the semiconductor wafer W is loaded into the designated process room PM (the process ship PS) only and processed (108). When all the semiconductor wafers W of the loaded lot are processed (109), information on the process room PM (the last process PM) having performed the last processing is stored (107), and the current processing is terminated.

As described above, the controller MC stores information on the process room PM (the last process PM) which has performed the last processing according to this embodiment, and when the next lot is in the OR transport mode, loading of the semiconductor wafer W into the next process room (e.g., the process room PM2 when the last process PM is the process room PM1) of the last process PM is started.

Therefore, the two process rooms PM1, PM2 (the process ships PS1, PS2) can be used evenly, and variations in maintenance cycles and the wearing of parts can be suppressed.

For example, when the OR transport mode is selected and it is determined to start transporting always to the process room PM1 (the process ship PS1), 25 semiconductor wafers Ware processed by processing 13 semiconductor wafers W by the process room PM1 (the process ship PS1) and 12 semiconductor wafers W by the process room PM2 (the process ship PS2). Thus, there is a difference of one semiconductor wafer in terms of a frequency of use per lot (cassette). Therefore, if a maintenance cycle is determined to carry out after processing every 1500 (115 lots) semiconductor wafers W, and when the maintenance cycle is executed, a difference in frequency of use between the process room PM1 (the process ship PS1) and the process room PM2 (the process ship PS2) becomes 115 semiconductor wafers W. And, when an average processing time is determined to be 3.5 minutes, there is a difference in integrated use time of about 6.7 hours.

Under the above-described conditions according to this embodiment, a difference in frequency of use can be determined to be one or less in terms of the processed semiconductor wafers W and 3.5 minutes or less of one processing time in terms of a difference in integrated use time. Thus, the individual process ships PS1, PS2 can be prevented from having variations in maintenance cycles and in the wearing of parts, and the same maintenance of the individual process ships PS1, PS2 can be performed at the same time, so that the apparatus can be used in good conditions.

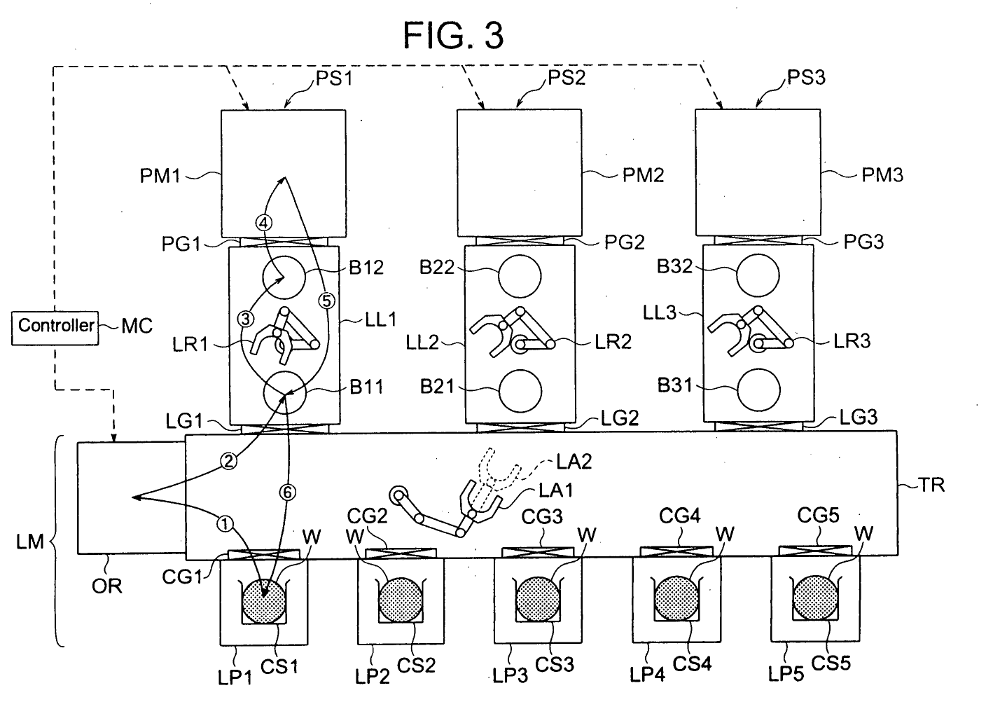

The above-described substrate processing apparatus of FIG. 1 was provided with the two process ships PS1, PS2 in order to simplify the description. But, the same procedure as described above can be applied where, for example, three process ships PS1, PS2, PS3 are disposed as shown in FIG. 3 or more process ships are disposed. The substrate processing apparatus of FIG. 3 is provided with five load ports LP1 to LP5, but the number of these load ports is not limited to a particular number.

This substrate processing apparatus has a determined processing order (a basic order of →PM1→PM2→PM3→PM1→ . . . ). Therefore, when information on the last process PM (process room for the last process) is stored, a process room which carries out the next processing can be determined. For example, when the last process PM (process room for the last process) is the process room PM2 (the process ship PS2), loading of the semiconductor wafer W to the process room PM3 (the process ship PS3) is started, and the semiconductor wafer W is loaded in order of the process room PM3→the process room PM1→the process room PM2.

Even if the processing order has not been determined in advance, information on the process room which carried out processing of (N−1) (N is a number of process rooms subject to the OR transport) semiconductor wafer W immediately before falling in an idle state is stored, so that a process room which carries out the next process can be determined. For example, where there are three process rooms and the process rooms which carried out processing of two semiconductor wafers W immediately before falling in an idle state are PM3→PM1→(idle), the process room which carries out the next process is PM2.

As described above, where there are three or more process ships PS, a difference in frequency of use under the above-described conditions can be determined to be within one in terms of the number of processed semiconductor wafers W and within 3.5 minutes of one process time in terms of a difference in integrated use time.

Time of returning from an idle state to a normal state may be variable for each process ship PS depending on the condition of the process ship PS. In such a case, the semiconductor wafers W are started to be loaded to, for example, the process room PM2 (the process ship PS2) according to the above-described sequence. And, if it takes a long time for the process room PM2 (the process ship PS2) to become ready to accept the semiconductor wafers W, there is a possibility that the loading of the semiconductor wafers W can not be started, resulting in dropping the throughput.

In such a case, while it takes a long time that the process room PM2 (the process ship PS2) becomes ready to accept the semiconductor wafers W, the process room PM1 (the process ship PS1) or the process room PM3 (the process ship PS3) might have become ready to accept the semiconductor wafers W.

Therefore, a time-out is set at the time of starting to load the semiconductor wafer W, and if the transport to the pertinent process room cannot be made with the time of the determined time-out, the semiconductor wafers W may be transported to the process room having the highest priority among other process rooms which are ready to accept the semiconductor wafers W.

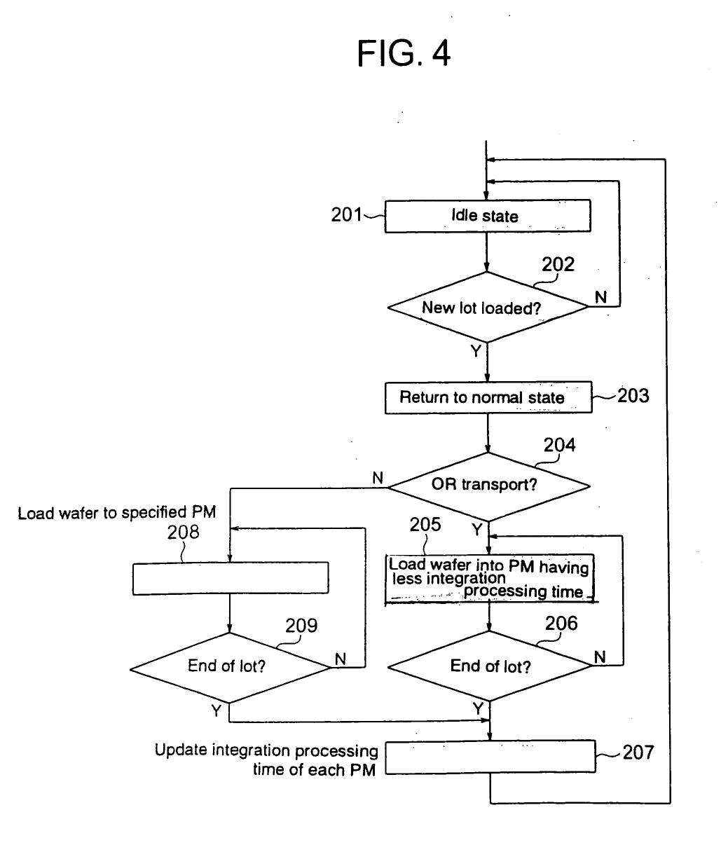

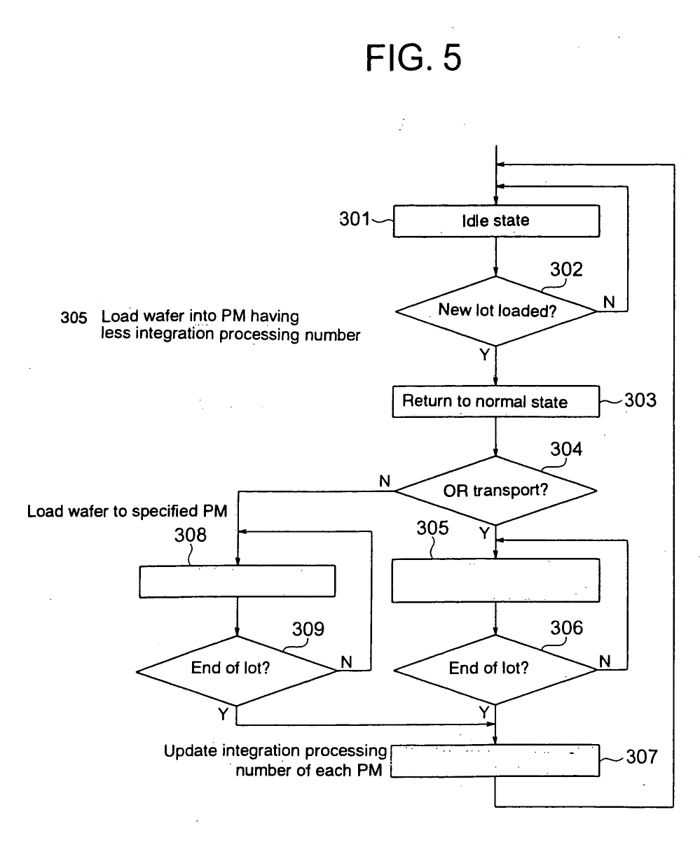

For example, the next process room is determined to be PM1 in the embodiment shown in FIG. 2, but if the transport to PM1 cannot be made within the time-out set time, PM2 having high priority, namely next to the PM1, is determined as the next process room. In the embodiment shown in FIG. 4 and FIG. 5, the throughput can be prevented from lowering by starting to transport with a process room which has priority next higher to the next process room, namely a process room having less integration processing time and fewer integrated processed number determined as the next process room. It is desirable that the time-out set time is determined to be variable as required.

In the above-described embodiment, the process room PM into which loading of the semiconductor wafers W of a new lot is started is determined by the last process PM (process room for the last process). It is also possible to configure as shown in, for example, FIG. 4 that the integration processing time of each process room PM is stored and updated sequentially (207), loading into the process room PM (the process ship PS) having the least integration processing time is started (205), the integrated processed number by each process room PM is stored and updated sequentially as show in FIG. 5 (307), and loading into the process room PM (the process ship PS) having the least integrated processed number is started (305).

As described above, when the integration processing time or the integrated processed number is stored and three or more process ships PS1, PS2, PS3 are provided as shown in FIG. 3, the loading order of the semiconductor wafers W as a whole can be determined in increasing order of integration processing time and integrated processed number as shown in FIGS. 4 and 5. In this case, when the process rooms PM are, for example, the process room PM2<the process room PM1<the process room PM3 in view of the integration processing time, the semiconductor wafers Ware loaded in order of the process room PM2→the process room PM1→the process room PM3.

Otherwise, it is also possible to determine only the process room PM (the process ship PS), into which loading is started at the start of processing, based on the integration processing time or the integrated processed number, and the ordinary order (sequence based on the process room PM1→the process room PM2→the process room PM3) can be adopted to the process room PM (the process ship PS) into which the next semiconductor wafer W is loaded next. The other procedures in FIGS. 4 and 5 are the same as those in FIG. 2.

By configuring as described above, even if mixing of modes other than the OR transport mode causes a difference in the integration processing time or the integrated processed number (frequency of use), the difference in the integration processing time or the integrated processed number (frequency of use) can be decreased.

The method of transporting with the load port gates CG1 to CG3 open was described in the above embodiment. But, the load port gates CG1 to CG3 may be closed temporarily if the time for transporting allows.

The state that the transfer room TR was open to the atmosphere was described as an example in the above-described embodiment, but the transfer room TR may be vacuumed. It was also described that the individual load lock rooms LL1, LL2 were provided with each two of the wafer mounting tables B11, B12 and B21, B22 but may be provided with a single wafer mounting table. And, the load lock arms LR1, LR2 may also be used as wafer mounting tables.

Besides, the loader arms LA1, LA2 described as examples were accessible to the near semiconductor wafer mounting tables B11, B21. But, they may be configured to be directly accessible to the back semiconductor wafer mounting tables B12, B22. And, the loader arms LA1, LA2 described had a two-stage structure but may have a single-stage structure.

As described above, the substrate processing apparatus and the substrate processing method according to the present invention allow the individual processing sections to be used evenly and minimize variations in maintenance cycles and in the wearing of parts in the processing sections.

### INDUSTRIAL APPLICABILITY

The substrate processing apparatus and the substrate processing method according to the present invention can be used in the semiconductor manufacturing industry and the like that produce semiconductor devices. Therefore, they have industrial applicability.

1. A substrate processing apparatus, comprising:
plural processing sections for carrying out a prescribed processing on a substrate to be processed;
a transport mechanism for transporting the substrate to be processed to the plural processing sections; and
a control unit for storing each integration processing time of the plural processing sections and controlling the transport mechanism to start transporting the substrate to be processed to the processing section having the stored least integration processing time when a next processing is started.

2. The substrate processing apparatus according to claim 1, wherein the control unit controls the transport mechanism to transport the substrate to be processed to the processing sections in increasing order of their stored integration processing time.

3. The substrate processing apparatus according to claim 2,
wherein the control unit controls to transport the substrate to be processed to the processing section having the highest priority among those capable of accepting the substrate to be processed when the processing sections, which are to transport the substrate to be processed, do not become ready to accept the substrate to be processed even after the expiration of a prescribed time interval.

4. The substrate processing apparatus according to claim 1, wherein the processing sections each have a load lock room, and the transport mechanism is configured to transport the substrate to be processed to the load lock room.

5. The substrate processing apparatus according to claim 1, wherein the plural processing sections carry out the same processing.

6. A substrate processing apparatus, comprising:
plural processing sections for carrying out a prescribed processing on a substrate to be processed;
a transport mechanism for transporting the substrate to be processed to the plural processing sections; and
a control unit for storing each integrated processed number by the plural processing sections and controlling the transport mechanism to start transporting the substrate to be processed to the processing section having the stored least integrated processed number when a next processing is started.

7. The substrate processing apparatus according to claim 6, wherein the control unit controls the transport mechanism to transport the substrate to be processed to the processing sections in increasing order of their stored integrated processed number.

8. The substrate processing apparatus according to claim 7, wherein the control unit controls to transport the substrate to be processed to the processing section having the highest priority among those capable of accepting the substrate to be processed when the processing section, to which the substrate to be processed is transported, does not become ready to accept the substrate to be processed even after the expiration of a prescribed time interval.

9. The substrate processing apparatus according to claim 6, wherein the processing sections each have a load lock room, and the transport mechanism is configured to transport the substrate to be processed to the load lock room.

10. The substrate processing apparatus according to claim 6, wherein the plural processing sections carry out the same processing.

11. A substrate processing method using a substrate processing apparatus which is provided with plural processing sections for carrying out a prescribed processing on a substrate to be processed and a transport mechanism for transporting the substrate to be processed to the plural processing sections in prescribed sequence,
wherein each integration processing time of the plural processing sections is stored, and transporting of the substrate to be processed to the processing section having the stored least integration processing time is started when a next processing is started.

12. The substrate processing method according to claim 11,
wherein the substrate to be processed is transported to the processing sections in increasing order of their stored integration processing time.

13. The substrate processing method according to claim 12,
wherein the substrate to be processed is transported to the processing section having the highest priority among those capable of accepting the substrate to be processed when the processing section, to which the substrate to be processed is transported, does not become ready to accept the substrate to be processed even after the expiration of a prescribed time interval.

14. The substrate processing method according to claim 11,
wherein the processing sections each have a load lock room, and the transport mechanism transports the substrate to be processed to the load lock room.

15. The substrate processing method according to claim 11,
wherein the plural processing sections carry out the same processing.

16. A substrate processing method using a substrate processing apparatus which is provided with plural processing sections for carrying out a prescribed processing on a substrate to be processed and a transport mechanism for transporting the substrate to be processed to the plural processing sections in prescribed sequence,
wherein each integrated processed number by the plural processing sections is stored, and transporting of the substrate to be processed to the processing section having the stored least integrated processed number is started when a next processing is started.

17. The substrate processing method according to claim 16,
wherein the substrate to be processed is transported to the processing sections in increasing order of their stored integrated processed number.

18. The substrate processing method according to claim 17,
wherein the substrate to be processed is transported to the processing section having the highest priority among those capable of accepting the substrate to be processed when the processing section, to which the substrate to be processed is transported, does not become ready to accept the substrate to be processed even after the expiration of a prescribed time interval.

19. The substrate processing method according to claim 16,
wherein the processing sections each have a load lock room, and the transport mechanism transports the substrate to be processed to the load lock room.

20. The substrate processing method according to claim 16,
wherein the plural processing sections carry out the same processing.
